(19) United States
(12) Patent Application Publication
(10) Pub. No.: US 2005/0086477 A1
(43) Pub. Date: Apr. 21, 2005

(54) Integrate PGP and Lotus Notes to encrypt / decrypt email

(75) Inventors: Ji Wei Lin, Hsin-chu (TW); Ray Ming Wang, Hsin chu City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co.

(21) Appl. No.: 10/687,193

(22) Filed: Oct. 16, 2003

(51) Int. Cl. H04L 9/00; G06F 15/16

(52) U.S. Cl. 713/171; 709/206

(57) ABSTRACT

This invention provides a method, a system and a computer program for integrating encryption/decryption software and email software. In addition, it provides a method and a computer program for integrating encryption software (Pretty Good Privacy) encryption/decryption software and Lotus Notes email software with minimal process steps. Encryption/decryption software is public-key encryption/decryption software. The user can send encrypted email with just one step of clicking the send button. Also, the user can read encrypted email and attachments with just one step of keying in the password.

### BACKGROUND OF THE INVENTION

1. Field of the Invention

This invention relates to a method and a computer program for integrating encryption/decryption software and email software. More particularly this invention relates to integrating PGP (Pretty Good Privacy) encryption/decryption software and Lotus Notes email software. More particularly this invention relates to integrating PGP and Lotus Notes with minimal process steps.

2. Description of Related Art

Lotus Notes is a commercial product to provide email service. PGP, Pretty Good Privacy is a commercial product to encrypt/decrypt files or data, such as text, graphs and embedded objects. When a user wants to do key management, such as changing PGP passwords, sending public keys to others or registering other's public keys at a key server, the user must know how to operated PGP software and understand several technical terms. This is usually not convenient for the average user. As can be seen below, the prior art methods are cumbersome and could be prohibitive for the average user.

FIG. 1 shows a prior art flowchart, which illustrates a method of sending encrypted email. The first step involves the copying of data to the clipboard 110. Next, PGP (Pretty Good Privacy) tool is launched 120. The next step 130 is to select all the receivers' keys to the encrypted data in the clipboard. Then, the encrypted data is posted in the clipboard as mail contents 140. The file manager is then opened in order to find the first attachment file listed 150. Next, right click on the attachment file to use the PGP tool to encrypt this attachment file 160. Then, select all receivers' keys to encrypt the attachment file 170. Then, attach the file to the mail body 180. The decision block 190 asks whether there are any more attachment files left to be attached to the mail body. If the answer is ‘yes’ 191, the method branches back to the open file manager step 150 mentioned previously. Then, the flow proceeds to 160, 170, 180 and 190 again. If the answer to the decision block question above is ‘NO’ 192, the method ex.5.

FIG. 2 shows a prior art flowchart, which illustrates a method of reading encrypted email. The first step involves opening the encrypted email 210. Next, the flow copies the whole mail content to the clipboard 220. Then, the PGP tool is launched 230. The user then must type the password of the PGP private key to decrypt the mail content 240. Next, the flow detaches all attachment files 250. The user then opens the file manager and finds the attachment file 260. The user then right clicks the attachment file to use the PGP tool to decrypt the attachment file 270. Next the user types the password of the PGP private key to decrypt the attachment file 280. Next in the flow is a decision block 290, which asks if there are more attachment files, which need to be processed. If the answer is ‘yes’ 291, the flow branches back to the open file manager block 260, and the flow repeats from there. If the answer is ‘No’ 292, the flow exits.

U.S. Pat. No. 6,272,632 B1 (Carman, et al.) “System and Method for Controlling Access to a User Secret Using a Key Recovery Field” describes a system and a method for data recovery. The system encrypts a message or file using a secret key and attaches a key recovery field and an access rule index.

U.S. Pat. No. 6,240,512 B1 (Fang, et al.) “Single Sign-On (SSO) Mechanism Having Master Key Synchronization” shows a method of sharing a master key across a set of servers operating a single sign-on (SSO) mechanism in a distributed computer network.

U.S. Pat. No. 6,161,149 (Achacoso, et al.) “Centrifugal Communication and Collaboration Method” shows a system and method for communicating information among members of a distributed discussion group having peripheral communication devices. The invention involves communication between the peripheral communication devices and a central agent.

U.S. Pat. No. 5,956,403 (Lipner, et al.) “System and Method for Access Field Verification” describes a system and method for key escrow cryptography for use in a system comprising a sender and a receiver.

### BRIEF SUMMARY OF THE INVENTION

It is the objective of this invention to provide a method and a computer program for integrating encryption/decryption software and email software.

It is further an objective of this invention to provide a method and a computer program for integrating PGP (Pretty Good Privacy) encryption/decryption software and Lotus Notes email software.

It is further an objective of this invention to provide a method and a computer program for integrating PGP and Lotus Notes with minimal process steps.

The objectives of this invention are achieved by a method for integrating PGP (Pretty Good Privacy) and Lotus Notes in order to encrypt/decrypt email. The steps include converting all recipients' addresses from Lotus/Notes format to Internet format, obtaining keys from PGP key server, using all recipients' PGP public keys to encrypt mail, using all recipients' PGP public keys to encrypt attachments and converting all recipients' addresses from internet format to Lotus Notes format. The method also includes providing a means for users to read PGP encrypted Notes mail, providing a means for users to read PGP encrypted Notes attachments, requesting users to type password of PGP private key decrypting mail content and decrypting attachment content. In addition, the invention provides for allowing users to use a familiar Lotus Notes interface to do PGP key management.

With this invention, the user can send encrypted email with just one step of clicking the send button. Also, with this invention, the user can read encrypted email and attachments with just one step of keying in the password.

### BRIEF DESCRIPTION OF THE DRAWINGS

FIG. 1 shows a prior art flowchart illustrating the sending of encrypted email and attachments.

FIG. 2 shows a prior art flowchart illustrating the reading of encrypted email and attachments.

FIG. 3 shows a flowchart of the invention illustrating the sending of email and attachments.

FIG. 4 shows a flowchart of the invention illustrating the reading of email and attachments.

FIG. 5 shows a more detailed flowchart illustrating the sending of encrypted email and attachments of the main embodiment of this invention.

FIG. 6 shows a more detailed flowchart illustrating the decrypting of encrypted email and attachments of the main embodiment of this invention.

FIG. 7 shows a more detailed flowchart illustrating the sending of a user's public key to the outside world of the main embodiment of this invention.

FIG. 8 shows a more detailed flowchart illustrating the registering of others' public keys in a key server of the main embodiment of this invention.

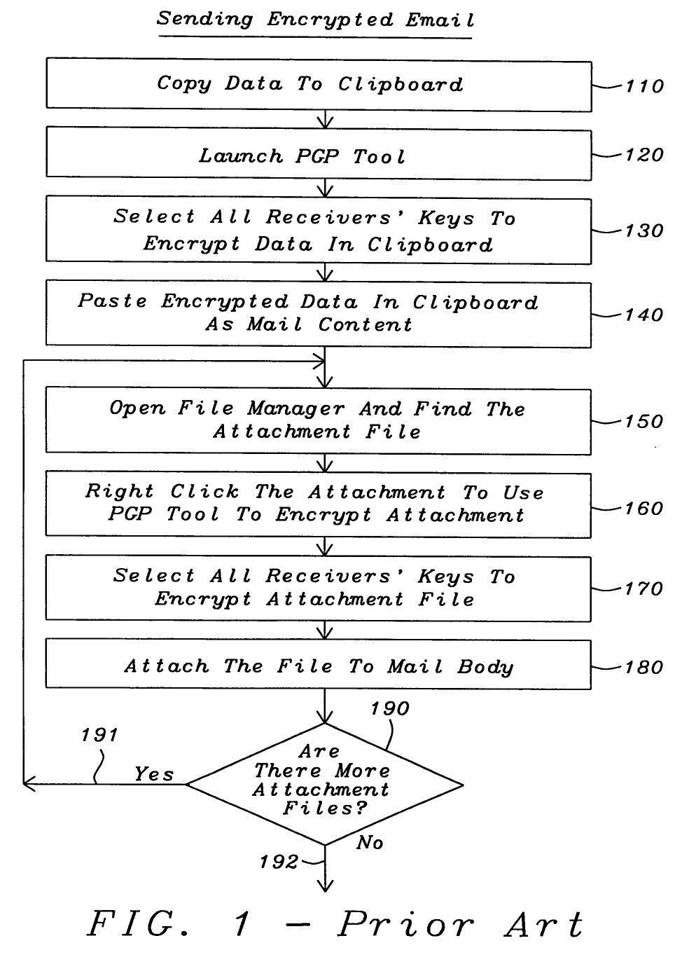

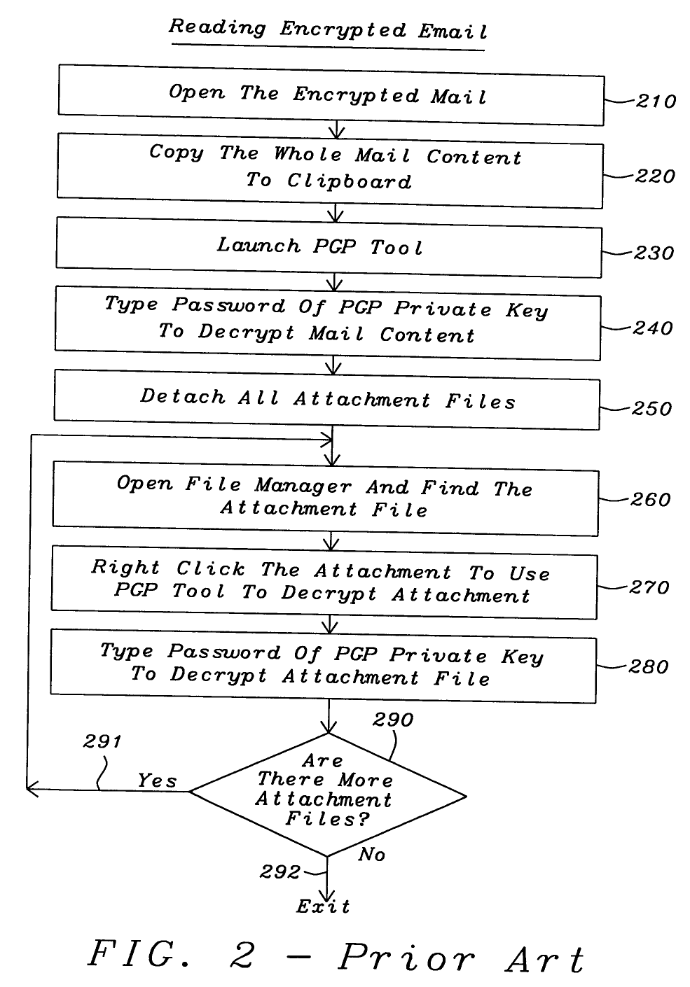

### DETAILED DESCRIPTION OF THE INVENTION

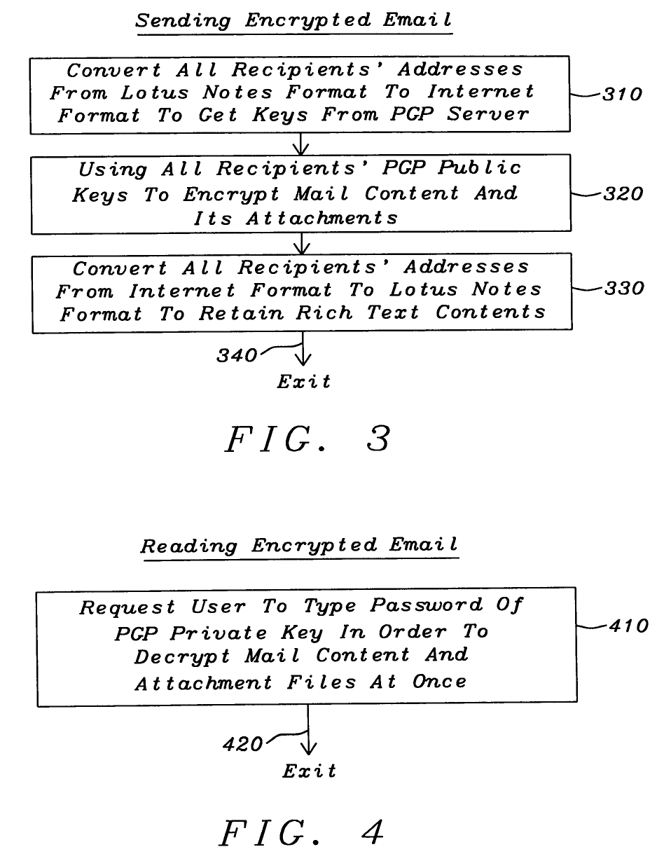

FIG. 3 shows a flowchart of the sending of encrypted email of the main embodiment of the invention. First, the flow converts all recipients' addresses from Lotus Notes format to Internet format 310. This step allows the method to get the keys from the PGP server. Next, the flow uses all recipients' PGP public keys to encrypt the mail contents and its attachment files 320. Finally, the flow converts all recipients' addresses from Internet format to Lotus Notes format to retain the rich text contents 330. Then, the flow exits 340.

FIG. 4 shows a flowchart of the reading of encrypted email of the main embodiment of the invention. The flow requests the user to type the password of a PGP private key 410. This is done in order to decrypt the mail content and all its attachment files all at once. Then, the flow exits 420.

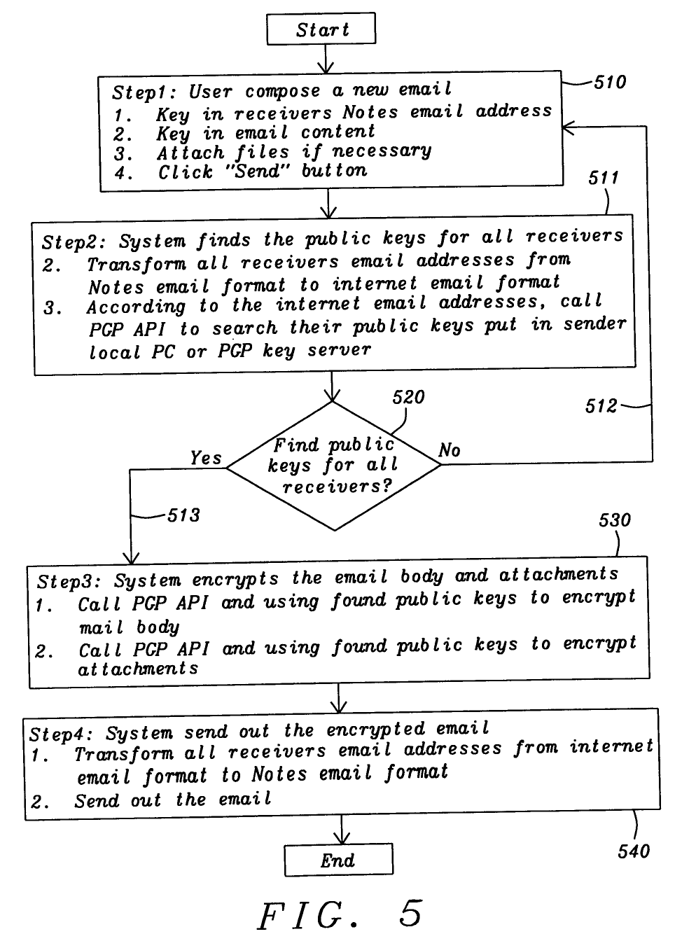

FIG. 5 shows a more detailed description of the sending of encrypted email. In step 1 (510), a user composes a new email. The user keys in the addresses of all the receivers of the email. Next, the user keys in the email message. Next, files are attached if necessary. Finally, the user clicks the “send” button to send the email.

The next block 511 in sequence has the system finding the public keys for all receivers of the email. The system transforms all of the receiver email addresses from Notes format to Internet email format. Next, according to the Internet email addresses, a call is made to the API of an encryption/decryption software such as PGP (Pretty Good Privacy). The call is to search for the receiver's public keys that were previously put in the sender's local PC or in a PGP key server.

The next block in FIG. 5 is a decision block 520. The decision block 520 asks the question, “were all public keys for all email receivers found?” If the answer is “No” 512, the program flow feeds back from 520 to block 510, in an attempt to successfully find the outstanding public keys. If the answer in block 520 is “Yes”, the system goes ahead to encrypt the email body and its attachments, 530. Finally in FIG. 5, the system sends out the encrypted email 540. It transforms all of the receivers' email addresses from Internet email format to Notes email format.

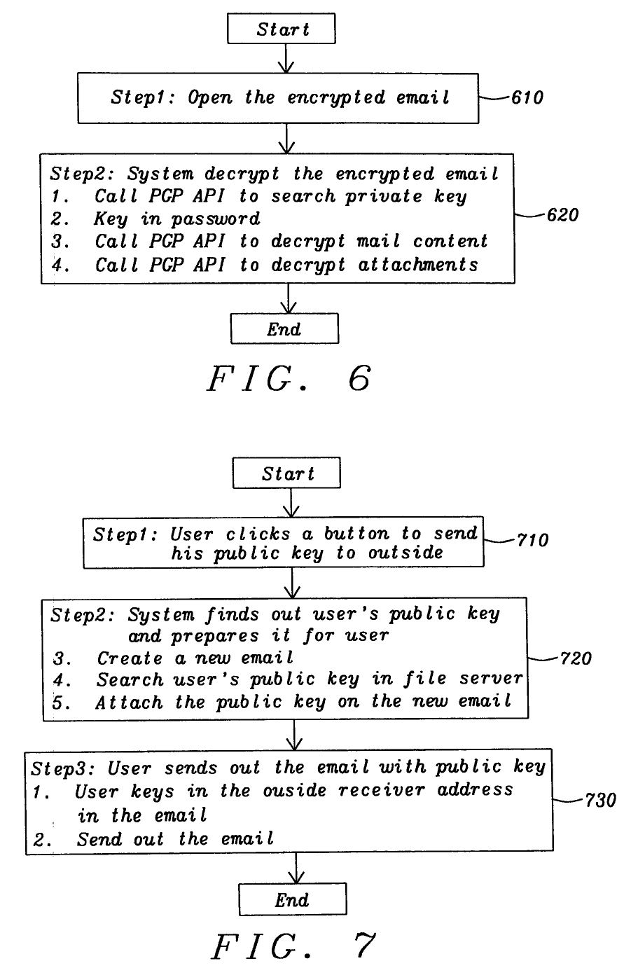

FIG. 6 shows a more detailed description of the receiving of encrypted email. In step 1 (610), the system opens the encrypted email. In step 2 (620), the system decrypts the encrypted email. The PGP encryption/decryption software API is called to search for a private key. The receiver keys in a password. The PGP API is called to decrypt the email contact. Finally, the PGP API is called to decrypt the attachments.

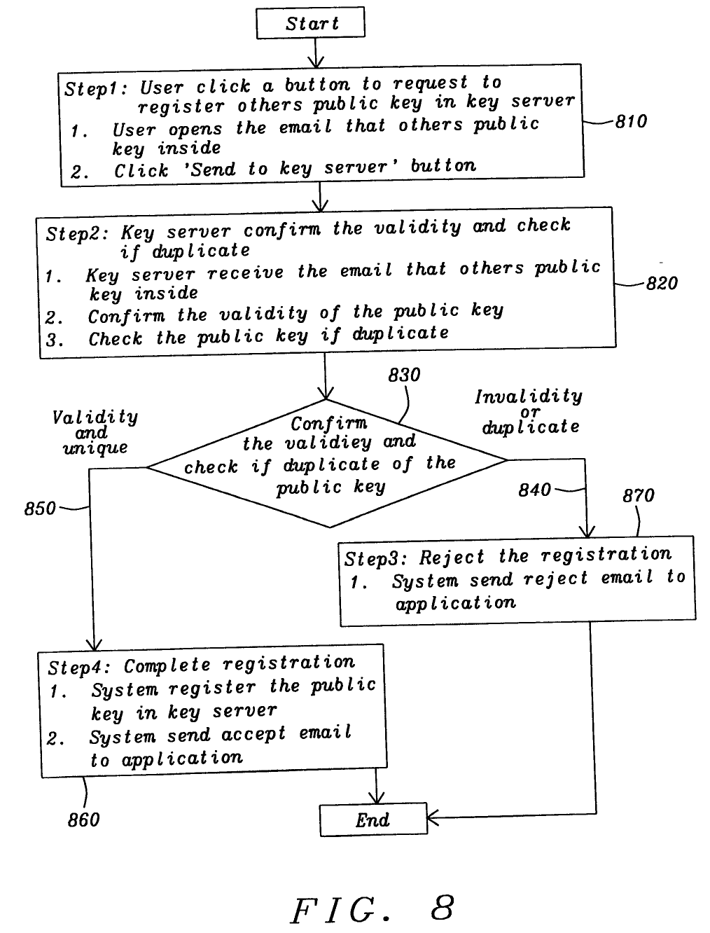

FIG. 7 shows a detailed description of how the user sends his public key to outside computers and servers. In step 1 (710) the user clicks a button to send his public key to the outside computing environment. Next, step 2 (720) shows how the system finds out a user's public key and prepares it for the user. After the user creates a new email, the system searches for the user's public key in the file server. Next, the system attaches the public key on the new email. Step 3 (730) shows the user sending out the email with a public key.

FIG. 8 shows how a user registers other's public keys in a key server. Step 1 (810) shows a user clicking a button to request to register other's public key in a key server. Next, the user opens the email that has other's public key inside. Next, the user clicks the “send to key server” button. Step 2 (820) shows how the key server confirms the validity of the key and checks for duplicates. This happens when the key server receives the email with other's public key inside. The server confirms the validity of the public key and checks if the public key is a duplicate. Step 3 is a decision block 830. Here the validity of the public key is checked. Also in (830) duplicate public keys are checked. The branch, which says the public key is valid and unique is 850. The branch, which says the public key is invalid or a duplicate is 840. Step 3 shows how the registration is rejected 870. The system sends a rejection email to the applicant. Step 4 shows how the registration is completed 860. The system registers the public key in a key server. The system sends accepted email to applicant.

There are several advantages of this invention. First, It provides a method and a computer program for integrating PGP and Lotus Notes with minimal process steps. With this invention, the user can send encrypted email with just one step of clicking the send button. Also, with this invention, the user can read encrypted email and attachments with just one step of keying in the password.

In addition to the above advantages, the user can use the Lotus Notes familiar interface to handle PGP key management. Users can change passwords of PGP private keys. They can register other PGP public keys at PGP key servers. Also, they can send out users PGP public keys to other people.

Another advantage of this invention is that users can benefit from the more readable and understandable customized error messages provided by Lotus Notes.

While this invention has been particularly shown and described with Reference to the preferred embodiments thereof, it will be understood by those Skilled in the art that various changes in form and details may be made without Departing from the spirit and scope of this invention.

1. A method for integrating an encryption/decryption system and an email platform in order to encrypt/decrypt email comprising the steps of:
converting a recipient's addresses from an email format to an Internet format;
obtaining a recipients public key from encryption software key server;
using said recipient's encryption software public keys to encrypt an email;
using said recipient's encryption software public keys to encrypt an attachment; and
converting said recipient's address from said internet format to said email format.

2. The method for integrating Public-key encryption software and Email software in order to encrypt/decrypt email of claim 1 further comprising the steps of:
providing a means for users to read encryption software encrypted email,
providing a means for users to read encryption software encrypted email attachments,
requesting users to type password of encryption software private key,
decrypting mail content, and
decrypting attachment content.

3. The method for integrating Public-key encryption software and Email software in order to encrypt/decrypt email of claim 1 further comprising the step of:
allowing users to use a familiar Email software interface to do encryption software key management.

4. The method for integrating Public-key encryption software and Email software in order to encrypt/decrypt email of claim 1 wherein said conversion of said addresses of said recipients' email addresses from Email software format to Internet format is required in order to obtain keys to proceed further.

5. The method for integrating Public-key encryption software and Email software in order to encrypt/decrypt email of claim 1 wherein said public keys are obtained from a encryption software server.

6. The method for integrating Public-key encryption software and Email software in order to encrypt/decrypt email of claim 1 wherein said keys are used to encrypt Email software email.

7. The method for integrating Public-key encryption software and Email software in order to encrypt/decrypt email of claim 1 wherein said keys are used to encrypt Email software attachments.

8. The method for integrating Public-key encryption software and Email software in order to encrypt/decrypt email of claim 1 wherein said Internet addresses are converted back to Email software format to allow email processing using said email software.

9. The method for integrating Public-key encryption software and Email software in order to encrypt/decrypt email of claim 1 wherein said conversion of said Internet addresses back to Email software addresses allows the retention of rich text content.

10. The method for integrating Public-key encryption software and Email software in order to encrypt/decrypt email of claim 1 wherein a means is provided for users to read said encryption software encrypted email.

11. The method for integrating Public-key encryption software and Email software in order to encrypt/decrypt email of claim 1 wherein a means is provided for users to read said encryption software encrypted attachments.

12. The method for integrating Public-key encryption software and Email software in order to encrypt/decrypt email of claim 1 wherein said users are requested to type in a password of a encryption software private key.

13. The method for integrating Public-key encryption software and Email software in order to encrypt/decrypt email of claim 1 wherein said encryption software password and private key are used to decrypt mail content.

14. The method for integrating Public-key encryption software and Email software in order to encrypt/decrypt email of claim 1 wherein said encryption software password and private key are used to decrypt attachment files.

15. The method for integrating Public-key encryption software and Email software in order to encrypt/decrypt email of claim 1 wherein said users can use a familiar Email software interface in order to handle encryption software key management.

16. The method for integrating Public-key encryption software and Email software in order to encrypt/decrypt email of claim 1 wherein said encryption software key management includes changing said password of said encryption software private key.

17. The method for integrating Public-key encryption software and Email software in order to encrypt/decrypt email of claim 1 wherein said encryption software key management also includes registering other encryption software public keys with said encryption software key server.

18. The method for integrating Public-key encryption software and Email software in order to encrypt/decrypt email of claim 1 wherein said encryption software key management also includes sending out said user's encryption software public key to other people.

19. A system for integrating Public-key encryption software and Email software in order to encrypt/decrypt email comprising:
means for converting all recipients' addresses from said email software format to Internet format,
means for obtaining keys from encryption software key server,
means for using all recipients' encryption software public keys to encrypt mail,
means for using all recipients' encryption software public keys to encrypt attachments, and
means for converting all recipients' addresses from internet format to Email software format.

20. The system for integrating Public-key encryption software and Email software in order to encrypt/decrypt email of claim 19 further comprising:
means for providing a means for users to read encryption software encrypted email software mail,
means for providing a means for users to read encryption software encrypted email softwareattachments,
means for requesting users to type password of encryyption software private key decrypting mail content and decrypting attachment content.

21. The system for integrating Public-key encryption software and Email software in order to encrypt/decrypt email of claim 19 further comprising the step of:
allowing users to use a familiar Email software interface to do encryption software key management.

22. The system for integrating Public-key encryption software and Email software in order to encrypt/decrypt email of claim 19 wherein said conversion of said addresses of said recipients' email addresses from Email software format to Internet format is required in order to obtain keys to proceed further.

23. The system for integrating Public-key encryption software and Email software in order to encrypt/decrypt email of claim 19 wherein said public keys are obtained from an encryption software server.

24. The system for integrating Public-key encryption software and Email software in order to encrypt/decrypt email of claim 19 wherein said keys are used to encrypt Email software email.

25. The system for integrating Public-key encryption software and Email software in order to encrypt/decrypt email of claim 19 wherein said keys are used to encrypt Email software attachments.

26. The system for integrating Public-key encryption software and Email software in order to encrypt/decrypt email of claim 19 wherein said Internet addresses are converted back to Email software format to allow email processing using said email software.

27. The system for integrating Public-key encryption software and Email software in order to encrypt/decrypt email of claim 19 wherein said conversion of said Internet addresses back to Email software addresses allows the retention of rich text content.

28. The system for integrating Public-key encryption software and Email software in order to encrypt/decrypt email of claim 19 wherein a means is provided for users to read said encryption software encrypted email.

29. The system for integrating Public-key encryption software and Email software in order to encrypt/decrypt email of claim 19 wherein a means is provided for users to read said encryption software encrypted attachments.

30. The system for integrating Public-key encryption software and Email software in order to encrypt/decrypt email of claim 19 wherein said users are requested to type in a password of said encryption software private key.

31. The system for integrating Public-key encryption software and Email software in order to encrypt/decrypt email of claim 19 wherein said encryption software password and private key are used to decrypt mail content.

32. The system for integrating Public-key encryption software and Email software in order to encrypt/decrypt email of claim 19 wherein said encryption software password and private key are used to decrypt attachment files.

33. The system for integrating Public-key encryption software and Email software in order to encrypt/decrypt email of claim 19 wherein said users can use a familiar Email software interface in order to handle encryption software key management.

34. The system for integrating Public-key encryption software and Email software in order to encrypt/decrypt email of claim 19 wherein said encryption software key management includes changing said password of said encryption software private key.

35. The system for integrating Public-key encryption software and Email software in order to encrypt/decrypt email of claim 19 wherein said encryption software key management also includes registering other encryption software public keys with said encryption software key server.

36. The method for integrating Public-key encryption software and Email software in order to encrypt/decrypt email of claim 19 wherein said encryption software key management also includes sending out said user's encryption software public key to other people.

37. A program retention device containing program instruction code executable on at least one networked computing device for integrating Public-key encryption software and Email software in order to encrypt/decrypt email whereby said program performs the steps of:
converting all recipients' addresses from email software format to Internet format,
obtaining keys from encryption software key server,
using all recipients' encryption software public keys to encrypt mail,
using all recipients' encryption software public keys to encrypt attachments and
converting all recipients' addresses from internet format to email software format.

38. The program retention device containing program instruction code executable on at least one networked computing device for integrating Public-key encryption software and Email software in order to encrypt/decrypt email program retention device containing program instruction code executable on at least one networked computing deviceof claim 37 whereby said program further performs the steps of:
providing a means for users to read encryption software encrypted email software mail,
providing a means for users to read encryption software encrypted email software attachments,
requesting users to type password of encryption software private key,
decrypting mail content, and
decrypting attachment content.

39. The program retention device containing program instruction code executable on at least one networked computing device for integrating Public-key encryption software and Email software in order to encrypt/decrypt email of claim 37 further comprising the step of:
allowing users to use a familiar Email software interface to do encryption software key management.

40. The program retention device containing program instruction code executable on at least one networked computing device for integrating Public-key encryption software and Email software in order to encrypt/decrypt of claim 37 wherein said conversion of said addresses of said recipients' email addresses from Email software format to Internet format is required in order to obtain keys to proceed further.

41. The program retention device containing program instruction code executable on at least one networked computing device for integrating Public-key encryption software and Email software in order to encrypt/decrypt email of claim 37 wherein said public keys are obtained from a encryption software server.

42. The program retention device containing program instruction code executable on at least one networked computing device for integrating Public-key encryption software and Email software in order to encrypt/decrypt email of claim 37 wherein said keys are used to encrypt Email software email.

43. The program retention device containing program instruction code executable on at least one networked computing device for integrating Public-key encryption software and Email software in order to encrypt/decrypt email of claim 37 wherein said keys are used to encrypt Email software attachments.

44. The program retention device containing program instruction code executable on at least one networked computing device for integrating Public-key encryption software and Email software in order to encrypt/decrypt email of claim 37 wherein said Internet addresses are converted back to Email software format to allow email processing using said email software.

45. The program retention device containing program instruction code executable on at least one networked computing device for integrating Public-key encryption software and Email software in order to encrypt/decrypt email of claim 37 wherein said conversion of said Internet addresses back to Email software addresses allows the retention of rich text content.

46. The program retention device containing program instruction code executable on at least one networked computing device for integrating Public-key encryption software and Email software in order to encrypt/decrypt email of claim 37 wherein a means is provided for users to read said encryption software encrypted email.

47. The program retention device containing program instruction code executable on at least one networked computing device for integrating Public-key encryption software and Email software in order to encrypt/decrypt email of claim 37 wherein a means is provided for users to read said encryption software encrypted attachments.

48. The program retention device containing program instruction code executable on at least one networked computing device for integrating Public-key encryption software and Email software in order to encrypt/decrypt email of claim 37 wherein said users are requested to type in a password of a encryption software private key.

49. The program retention device containing program instruction code executable on at least one networked computing device for integrating Public-key encryption software and Email software in order to encrypt/decrypt email of claim 37 wherein said encryption software password and private key are used to decrypt mail content.

50. The program retention device containing program instruction code executable on at least one networked computing device for integrating Public-key encryption software and Email software in order to encrypt/decrypt email of claim 37 wherein said encryption software password and private key are used to decrypt attachment files.

51. The program retention device containing program instruction code executable on at least one networked computing device for integrating Public-key encryption software and Email software in order to encrypt/decrypt email of claim 37 wherein said users can use a familiar Email software interface in order to handle encryption software key management.

52. The program retention device containing program instruction code executable on at least one networked computing device for integrating Public-key encryption software and Email software in order to encrypt/decrypt email of claim 37 wherein said encryption software key management includes changing said password of said encryption software private key.

53. The program retention device containing program instruction code executable on at least one networked computing device for integrating Public-key encryption software and Email software in order to encrypt/decrypt email of claim 37 wherein said encryption software key management also includes registering other encryption software public keys with said encryption software key server.

54. The program retention device containing program instruction code executable on at least one networked computing device for integrating Public-key encryption software and Email software in order to encrypt/decrypt email of claim 37 wherein said encryption software key management also includes sending out said user's encryption software public key to other people.
